(19) United States
(12) Patent Application Publication
(10) Pub. No.: US 2005/0029020 A1
(43) Pub. Date: Feb. 10, 2005

(54) Points cover with rotating accessory

(76) Inventor: John Michael Luch, Englewood, CO (US)

Correspondence Address: Barber Legal, PO Box 16220, Golden, CO, 80402-6004, US

(21) Appl. No.: 10/912,934

(22) Filed: Aug. 6, 2004

Related U.S. Application Data
(60) Provisional application No. 60/493,102, filed on Aug. 6, 2003.

(51) Int. Cl. B60K 17/28; B62M 7/00; B62D 61/02

(52) U.S. Cl. 180/53.1

(57) ABSTRACT

The invention comprises a motorcycle camshaft or transmission drive shaft driven, threaded metal shaft encased in a bearing and oil seal, projecting through a points cover plate (or transmission cover/Derby cover exposing an ornamental (decorative) object or power driven tool that provides relative movement from the spinning shaft. The decorative element may take the shape of a die, fan, skull, small figure or other such element that may use the relative movement of the drive shaft to be decorative. The fixed positioned points cover plate may be an additional decorative element that may enhance the moving decorative element.

### CROSS REFERENCE TO RELATED APPLICATIONS

This application and device claim the benefit of provisional application No. 60/493,102 filed in the United States Patent and Trademark Office on Aug. 5^{th}, 2003 with the same title and in the name of the same inventor, John Luch.

### FIELD OF THE INVENTION

This invention relates generally to motorcycles and specifically to a camshaft driven accessories.

### STATEMENT REGARDING FEDERALLY FUNDED RESEARCH

This invention was not made under contract with an agency of the US Government, nor by any agency of the US Government.

### BACKGROUND OF THE INVENTION

There are many applications of the internal combustion engine in vehicles, which include transporting people and heavy items as well as redirecting the power of the engine for other uses in service vehicles. Many engines in trucks or service vehicles may have an accessory component which may be attached (such as a compressor, pump, generator or winch) that may utilize an assortment of gears, pulleys and cables to redirect the power of the engine. Coupling directly from the engine's main shaft to any of several accessories harnesses the power and relative movement of the engine shaft.

It is known to use the power of the engine camshaft to power other parts of the engine such as a fuel pump, water pump or the like.

One example of such an invention allows for an accessory, mounted on the front end of a vehicle frame, adjacent to an engine driven component, to offer several mechanical applications for service vehicles U.S. Pat. No. 5,094,309 (Vlaanderen et al). However, the applicant is unaware of any devices which take power from the engine of a motorcycle.

For decades on farms in the back country and in businesses throughout North America and the world, the concept of utilizing an attached accessory to the drive shaft of service vehicles has solved many problems when other power sources were not available. These accessories allowed fields to be cleared by extricating tree stumps from the ground, splitting wood, digging trenches, powering other devices or pulling other service vehicles and objects from gullies and culverts.

However, while it is known that the direct power from the engine drive shaft may serve many uses, no related patented devices are known to applicant that utilize the drive shaft of an engine directly for the purpose of decorative use. It would be advantageous to have a device, which utilizes and attaches to an existing, pre-threaded drive shaft to provide a decorative element with relative movement.

In addition, no power transfer from a motorcycle engine is known, thus power take off from a motorcycle engine would be advantageous for decoration or powering of tools other than the motorcycle engine itself and components thereof such as the fuel pump, etc.

Modem motorcycle engines tend to be multi stroke, multi cylinder engines featuring spinning camshafts and transmission shafts.

### SUMMARY OF THE INVENTION

General Summary

The invention comprises a motorcycle camshaft driven, threaded metal shaft passing through a bearing and oil seal and projecting through a points cover plate and thus exposing on the outside of the motorcycle an ornamental (decorative) object that receives relative movement from the spinning drive shaft. The decorative element may take the shape of a die, fan, skull, small figure or other such element that may use the relative movement of the drive shaft to be decorative. The fixed positioned points cover plate may be an additional decorative element that may enhance the moving decorative element.

Summary in Reference to Prototypical Claim

It is yet another aspect, advantage, objective and embodiment of the present invention to provide a decorative accessory for motorcycles comprising: a metal shaft having distal and proximal ends; the shaft attached coaxially to the motorcycle engine camshaft; the shaft having a material and thickness sufficient to withstand the stresses imposed by attachment to the motorcycle engine camshaft; a points cover plate having a passage dimensioned and configured to accept the shaft therethrough with the proximal end within the motorcycle engine camshaft case and the distal end outside of the motorcycle engine; the distal end having a connection to an accessory external to the motorcycle.

It is yet another aspect, advantage, objective and embodiment of the present invention to provide a decorative accessory for motorcycles wherein the connection to the external accessory comprises external threading on the shaft.

It is yet another aspect, advantage, objective and embodiment of the present invention to provide a decorative accessory for motorcycles wherein the attachment to the motorcycle engine camshaft comprises external threading dimensioned and configured to physically engage the internal threading at the end of the motorcycle engine camshaft.

It is yet another aspect, advantage, objective and embodiment of the present invention to provide a decorative accessory for motorcycles wherein the passage further comprises an oil seal.

It is yet another aspect, advantage, objective and embodiment of the present invention to provide a decorative accessory for motorcycles wherein the passage further comprises a bearing.

It is yet another aspect, advantage, objective and embodiment of the present invention to provide a decorative accessory for motorcycles wherein the external accessory further comprises an ornament.

It is yet another aspect, advantage, objective and embodiment of the present invention to provide a decorative accessory for motorcycles wherein the ornament further comprises a simulacra of a portion of a revolver cylinder.

It is yet another aspect, advantage, objective and embodiment of the present invention to provide a decorative accessory for motorcycles wherein the ornament further comprises at least one cartridge case. It is yet another aspect, advantage, objective and embodiment of the present invention to provide a decorative accessory for motorcycles wherein the ornament further comprises a portion of a die.

It is yet another aspect, advantage, objective and embodiment of the present invention to provide a decorative accessory for motorcycles wherein the ornament further comprises a tool.

It is yet another aspect, advantage, objective and embodiment of the present invention to provide a decorative accessory for motorcycles comprising: a threaded metal shaft; a bearing and oil seal on the threaded metal shaft; a points cover plate, the threaded metal shaft passing through the points cover plate at the bearing and oil seal; an ornament at a first end of the shaft; a second end of the shaft being connected to such motorcycle's camshaft; whereby the ornament spins due to the motion of such drive shaft.

It is another aspect, advantage, objective and embodiment of the present invention to provide a motorcycle external accessory drive comprising: a metal shaft having distal and proximal ends; the shaft attached coaxially to the motorcycle transmission drive shaft; the shaft having a material and thickness sufficient to withstand the stresses imposed by attachment to the motorcycle transmission drive shaft; a points cover plate having a passage dimensioned and configured to accept the shaft therethrough with the proximal end within the motorcycle engine camshaft case and the distal end outside of the motorcycle; the distal end having a connection to an accessory external to the motorcycle.

It is another aspect, advantage, objective and embodiment of the present invention to provide a motorcycle external accessory drive wherein the connection on the distal end further comprises a slip fit which under a first imposed torque causes the accessory to rotate with the shaft, and under a second imposed torque causes the accessory to slip in relation to the shaft rotation.

### BRIEF DESCRIPTION OF THE DRAWINGS

FIG. 1 is a perspective view of the first embodiment of the invention, showing the points cover on an engine.

FIG. 2 is a side view of the first embodiment of the invention, schematically showing the motorcycle side profile.

FIG. 3 is a perspective forward view of the first embodiment of the invention.

FIG. 4 is a perspective rear view of the first embodiment of the invention.

FIG. 5 is a perspective side view of the first embodiment of the invention.

FIG. 6 is an exploded perspective view of the first embodiment of the invention, in relation to the motorcycle engine.

FIG. 7a is a perspective forward view of the first embodiment of the invention.

FIG. 7b is a perspective rear view of the first embodiment of the invention.

FIG. 7c is a perspective side view of the first embodiment of the invention.

FIG. 8 is a perspective view of the first embodiment of the invention, showing a potential foot guard.

FIG. 9 is a perspective view of the first embodiment of the invention, showing the motorcycle side profile and a potential transparent safety cover.

FIG. 10 is a perspective side view of the first embodiment of the invention, showing a potential transparent safety cover.

FIG. 11 is an exploded view of a motorcycle engine shaft, a drive shaft and accessories of the invention.

### INDEX TO REFERENCE NUMERALS

51 Ornamental (decorative) object
52 Oil seal/bearing
53 Points cover plate
54 Drive shaft
55 Mounting bolt holes
56 Points cover bolts
57 Motorcycle engine
58 Motorcycle points cover hole
59 Motorcycle camshaft
60 Metal foot guard
61 Motorcycle camshaft case
62 Clear dome guard
63 Flats machined into drive shaft
70 Internally threaded camshaft
80 Drive shaft
82 Proximal end threads
84 Distal end threads
86 Transmission drive shaft
88 Simulacra of revolver cylinder
90 Portion of cartridge

### DETAILED DESCRIPTION

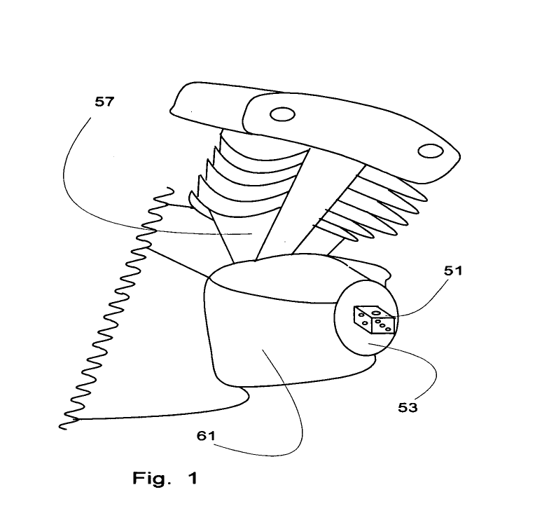

The primary embodiment of the invention shows the usually shiny, smooth surface of the points cover plate 53 on the engine FIG. 1 of a two-stroke or preferentially four-stroke motorcycle where stock manufacturing, such as Harley Davidson, provides an access to the motorcycle internally threaded camshaft 70 via a points cover hole 58 allowing the receipt of the invention's drive shaft 54. By replacing the stock points cover with a specialty cover as disclosed herein, access to the power of the camshaft may be provided to external accessories other than the engine. (It is of course known in the art to use the power of a motorcycle engine camshaft to power other parts of the engine such as a fuel pump, water pump, fan or the like. The present invention is not concerned with internal engine uses but rather with providing power to external accessories.)

The drive shaft 54 must be of a construction sufficient to withstand the forces generated by the motorcycle engine, which vary considerably from the torques and RPMs generated by most other vehicle engines.

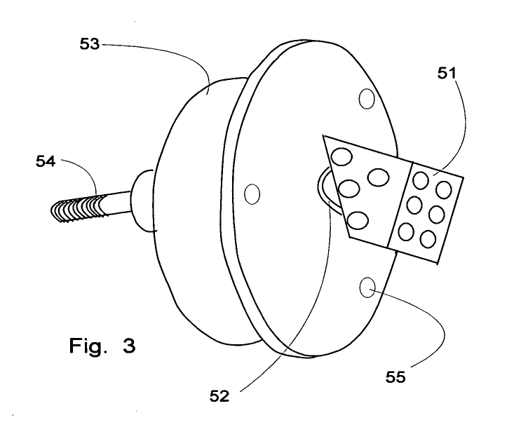

The external accessory may be an ornament. Ornamental (decorative) object 51, found on the opposite end of the device drive shaft 54 from the camshaft, may take the shape of a die that has been sliced diagonally exposing an angle view, as seen on FIG. 3. This presently preferred embodiment and best mode now contemplated for the invention and the decorative element 51, although angular may have rounded edges and may have an enameled, contrasting color surface which emphasizes the die motif. “Pips” (spots on the sides of the die indicating the numbers from 1 to 6, or a subset thereof) may be provided to enhance realism.

Another presently preferred embodiment teaches that the accessory may be a different decorative object: a simulacra of the butt end of a revolver cylinder, with or without a number of simulated or used cartridge cases exposed.

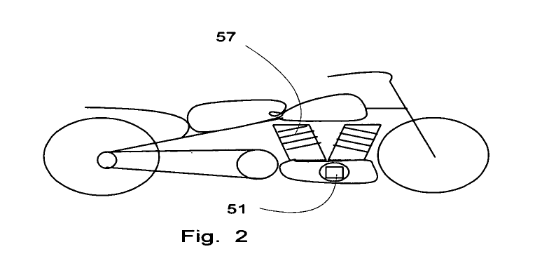

A side view (FIG. 2) illustrates the location and relative proportions of the device compared to an engine 57 on a diagram of a motorcycle. It will be appreciated that the preferred embodiment is fairly small in proportion to the overall motorcycle, but it will be eye-catching by virtual of its relative motion (spinning) in relation to the motorcycle, and it may be made more eye-catching in construction by use of bright colors, shiny construction, increased size, etc. The components of the primary embodiment of the invention can be seen from a forward view, FIG. 3. The proportions of the ornamental (decorative) object 51 can be seen compared to the rest of the invention in FIG. 3 as it is attached via welding, threading or adhesive to the outside and visible end of the drive shaft 54 which projects through the points cover plate 53 and is held securely in place by the bearing and oil seal 52. The primary embodiment of the points cover plate 53 may have a shiny, smooth, metallic surface although alternative embodiments may show machined designs such as swirls, brushed metal, blued metal, or antiqued metal; scribing such as diamond and cross-hatching shapes or decorative flourishes; wording such as “Rollin' Die”, “Russian Roulette” or “Born to Ride”; or painted designs such as roses or flames to complement the decorative element 51.

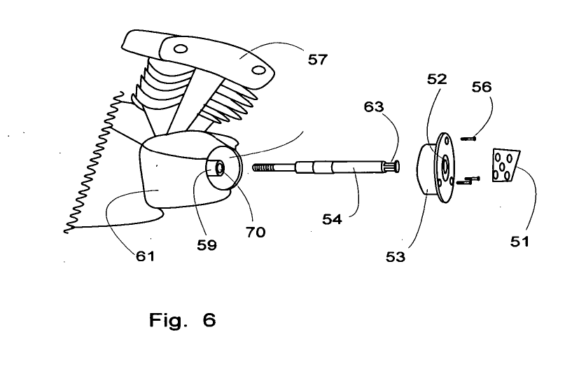

Points cover plate 53 also has mounting bolt holes 55 positioned to meet existing holes on the motorcycle's camshaft case, FIG. 6, reference number 61. The device drive shaft 54, as well as the remainder of the invention, may be composed of machined steel, which may be appropriate, and as torque tolerant as parts found in a motorcycle engine. In general, it is preferable to make the device strong as breakage of parts of the device inside of the cover plate 53 might result in engine damage.

Points cover plate 53 is dimensioned and configured to be accepted on the motorcycle engine crankcase as a replacement for a normal (non-pierced) points cover. Obviously this shape and size is considerably different from the shape and size of points covers or crankcase/camshaft cases for other vehicle engines: automobile engines, truck engines, marine engines and the like are of considerably different geometry and would not necessarily allow power take off directly from the camshaft through the points cover to an accessory actually external to the entire vehicle. For example, in certain engines, the camshaft is not accessible by this cover, and in most vehicles, the engine is covered and thus a camshaft power take off directly through a cover would lead only to the interior of an engine compartment. In such non-analogous vehicles, a camshaft power take off for external usage would require that the structures to transmit power from the engine compartment to a genuinely external accessory would argue against the use of a simple shaft as in the present invention.

In one alternative embodiment, the ornament 51 may have a relatively large “breakaway” portion which is attached to a relatively smaller and stronger visible end of shaft 54. In the event of accidental fouling of the ornament 51 by an exterior object, the ornament will shear away but the smaller shaft head will be freed to continue spinning, thus avoiding engine damage or damage to whatever may foul the external accessory.

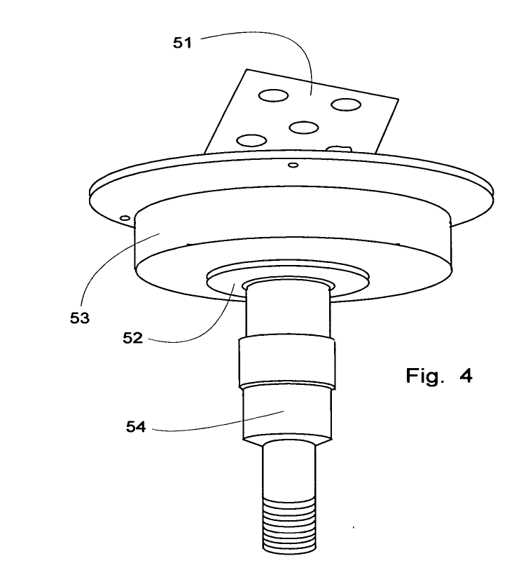

The rearward view shown on FIG. 4 gives the reader detail of the invention's threaded drive shaft 54 which threads directly into a camshaft 59 of a motorcycle such as a Harley Davidson. The bearing and oil seal 52 contains oiled bearings that keeps the device drive shaft 54 of the invention lubricated for easy, relative movement of the ornamental (decorative) object 51 as it is held in place by the points cover plate 53. Oil seal 52 is important in preventing oil leaks to which motorcycle engines may be prone.

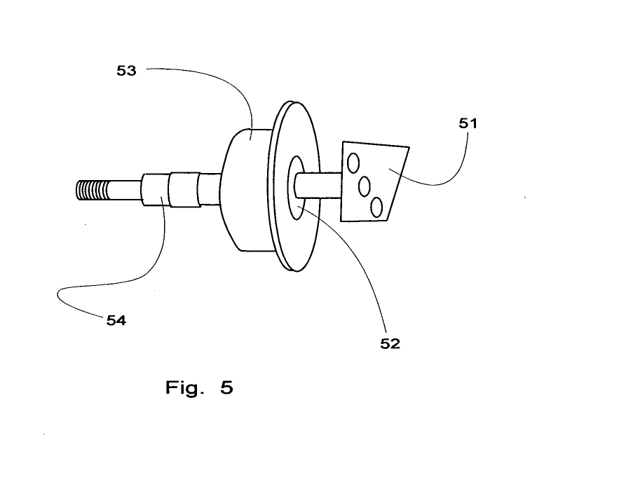

The side view of FIG. 5, Reference Numbers 51 through 54 show the relationship and relative proportions each part has with each other. Ornamental (decorative) object 51 may be manufactured onto, bolted, glued or threaded to the exposed end of the drive shaft 54 which, as stated previously, is held in place by a oil seal/bearing 52 which passes through the points cover plate 53 and terminates with threading or other connection means on the visible/outside of the end of the drive shaft 54. At the inside end, the externally threaded shaft 54 attaches to the internally threaded motorcycle camshaft hole 70.

Other methods of attachment to the camshaft may be employed without departing from the scope of the invention.

Referring to FIG. 6, a perspective view of the first embodiment of the invention is shown, which depicts an exploded view and placement of the device and its general relationship for attachment to a motorcycle camshaft. FIG. 6, reference number 57 shows the engine of a motorcycle, the points cover hole 58 and the engine's exposed camshaft 59 and internally threaded camshaft 70. The individual parts of the device include the invention's threaded drive shaft 54, which attaches to the motorcycle camshaft 59 via complementary, male to female threading, and the area opposite the threaded end, which may be machined flat to form flat portion 63, thus facilitating tightening and loosening of the device drive shaft to the motorcycle camshaft 59, for example by wrench, as a home mechanic or hobbyist is likely to do. In an alternative embodiment, an “Allan” (inset hex) head may be “broached”, cast, machined or otherwise manufactured or set into the head of shaft 54, so that an Allan wrench may be used to tighten shaft 54 upon camshaft 59 or a transmission shaft in alternative embodiments using the transmission shaft. Motorcycle engine camshaft 59 may be equipped with such internal threading at the end, unlike most other vehicle engines, thus allowing physical engagement between properly dimensioned and configured threading on the drive shaft 54 and that in the camshaft 59.

The points cover plate 53, which screwed on via the points cover bolts 56 and fits over the motorcycle's points cover hole 58 at the engines camshaft case 61 and thus may include a second oil seal or gasket at its edge, depending upon the construction of the motorcycle. Oil seal/bearing 52 may be lubricated at the device drive shaft 54 by internal engine oil, thus providing ease of rotation of the device drive shaft 54 and while sealing oil within the motorcycle's camshaft case 61.

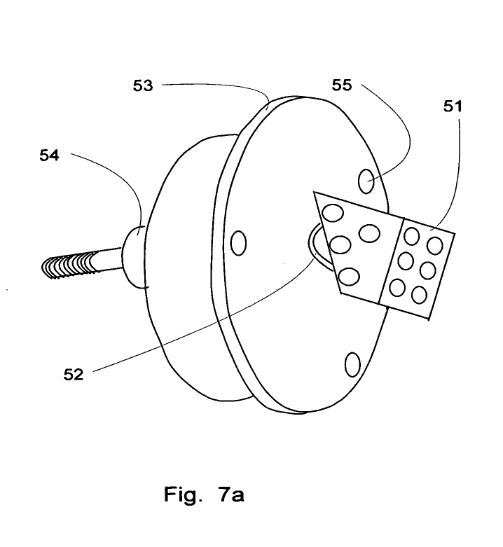

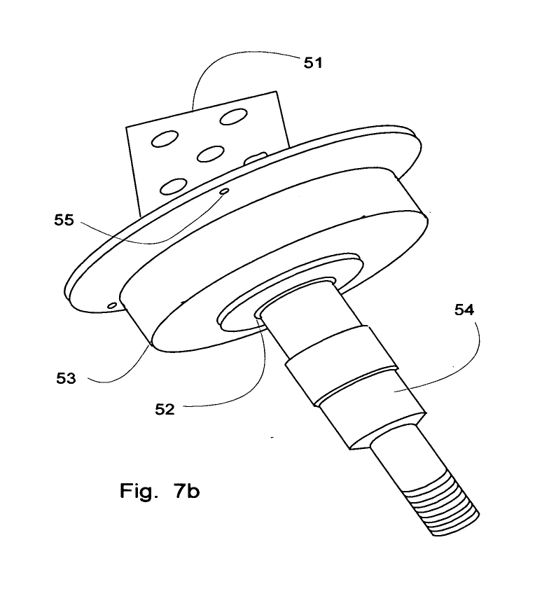

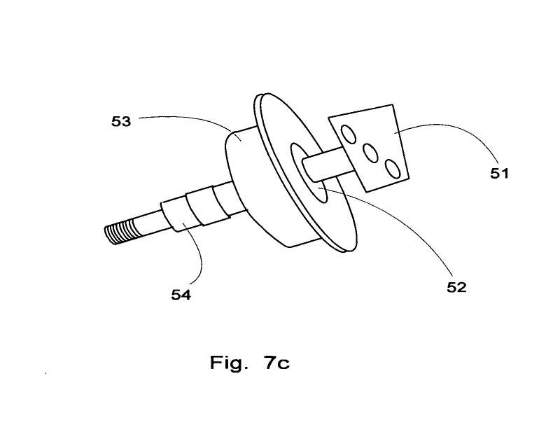

FIGS. 7a and b provide front and rear views of the primary embodiment with attention made to the positioning of the mounting bolt holes 55 which when drilled or formed through the points cover plate 53 at the locations appropriate to a given engine (that is, at the same places as the bolt holes through the stock points cover being replaced) readily bolts to a motorcycle camshaft case 61. Other major elements shown again include oil seal/bearing 52, drive shaft 54 and ornamental (decoration) object 51. FIG. 7c, reference numerals 51 through 54 provide a side view of the points cover with rotating accessory.

It will be seen that the characteristics of shaft 54 may vary along its length to suit requirements: it may be dimensioned and configured to easily attach to the camshaft of the cycle engine at the interior end, while the exterior end may be as small as is possible while allowing attachment to ornament 51. At other locations, shaft 54 may have diameter and cross section appropriate to cooperate with oil seal/bearing 52, to avoid internal engine components which may come close to the axis of rotation of shaft 54, for strength at points of higher torque, etc.

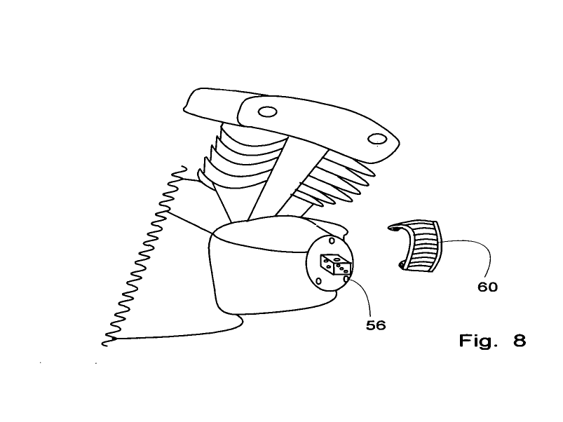

An alternative embodiment that provides a guard for the invention may take the form of a metal foot guard 60, FIG. 8. The metal foot guard 60 may be positioned in such a way as to utilize the existing mounting bolt holes 55 and may vary in size and relative shape to provide an adequate guard. Metal content for the foot guard 60 may be consistent with metal used in the invention as well as those found in construction of a motorcycle, or it may of a different grade as needed to prevent accidental foot contact with the ornament. Color and shape of the foot guard 60 may vary in keeping with a coordinated motif of the overall device.

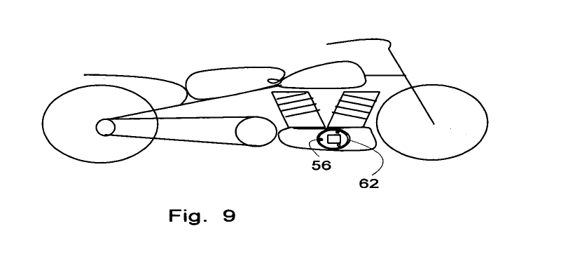

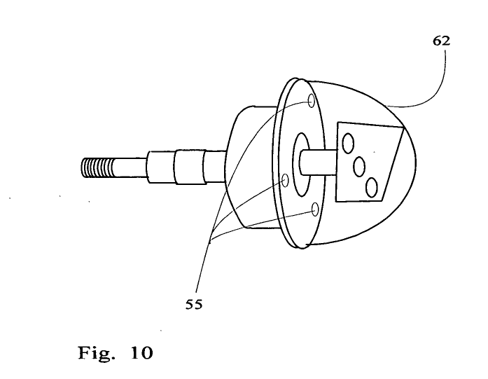

Another alternative embodiment that provides a guard for the invention may take the form of transparent dome guard 62, FIG. 10. The alternative embodiment may utilize the existing mounting bolt holes 55 and may be a plastic or acrylic although materials, size and relative shape may vary to provide an adequate guard. FIG. 9, reference numbers indicates the relative position of the transparent dome guard 62 as well as the existing mounting bolt holes 55 which may be utilized for securing the transparent dome guard 62 to the points cover plate 53. The transparency of this alternative embodiment allows viewing of the ornamental (decorative) object 51 and may increase the variety of decorative elements available for points cover with rotating accessory.

The device of the invention may be used with the primary and “Derby” covers of the transmission instead of the points cover, in which case the device shaft 54 is attached to the transmission drive shaft instead of the camshaft.

While the invention has been disclosed with a rotating accessory ornament, it will be appreciated that reciprocating motion may easily be derived from the power take off for use with other external accessories. And while the device is shown with a fixed ornament, it may easily have provision at the shaft head for easy removal and attachment of different ornaments and devices. For example mechanic's tools (air compressors, drills, etc) may be operated by this means, or devices entirely unrelated to motorcycles (power tools, agricultural equipment, sporting goods, etc) may be operated this way.

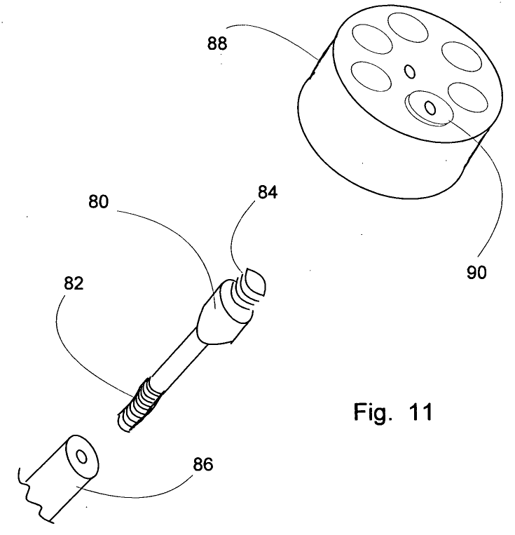

FIG. 11 is an exploded view of a motorcycle engine shaft, a drive shaft and accessories of the invention. Drive shaft 80 has two externally threaded ends, proximal end threads 82 and distal end threads 84. The points cover is not shown. Transmission drive shaft or camshaft 86 is connected to the drive shaft 80 by the threading or by other means as discussed. Simulacra of revolver cylinder 88 may have one or more cartridge portions 90. When in motion, the simulacra will rotate like a revolver cartridge being spun, for decorative effect.

It is another aspect of the present invention to provide a motorcycle external accessory drive wherein the connection on the distal end further comprises a slip fit which under a first imposed torque causes the accessory to rotate with the shaft, and under a second imposed torque causes the accessory to slip in relation to the shaft rotation. Thus in the embodiment of FIG. 11, the distal end threads 84 will cause the accessory 88 to rotate, however, if a greater torque is imposed (for example, by someone grabbing the rotating accessory or something becoming tangled therein), the accessory may slip upon the shaft 80. This safety feature may be used in any preferred or alternative embodiment of the invention.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying the corresponding utility application to be filed at a later date.

1. A motorcycle external accessory drive comprising:
a metal shaft having distal and proximal ends; the shaft attached coaxially to the motorcycle engine camshaft; the shaft having a material and thickness sufficient to withstand the stresses imposed by attachment to the motorcycle engine camshaft;
a points cover plate having a passage dimensioned and configured to accept the shaft therethrough with the proximal end within the motorcycle engine camshaft case and the distal end outside of the motorcycle engine;
the distal end having a connection to an accessory external to the motorcycle.

2. The motorcycle external accessory drive of claim 1, wherein the connection to the external accessory comprises external threading on the shaft.

3. The motorcycle external accessory drive of claim 1, wherein the attachment to the motorcycle engine camshaft comprises external threading dimensioned and configured to physically engage the internal threading at the end of the motorcycle engine camshaft.

4. The motorcycle external accessory drive of claim 1, wherein the passage further comprises an oil seal.

5. The motorcycle external accessory drive of claim 1, wherein the passage further comprises a bearing.

6. The motorcycle external accessory drive of claim 1, wherein the external accessory further comprises an ornament.

7. The motorcycle external accessory drive of claim 6, wherein the ornament further comprises a simulacra of a portion of a revolver cylinder.

8. The motorcycle external accessory drive of claim 7, wherein the ornament further comprises at least one cartridge case.

9. The motorcycle external accessory drive of claim 1, wherein the ornament further comprises a portion of a die.

10. The motorcycle external accessory drive of claim 1, wherein the ornament further comprises a tool.

11. A decorative element for motorcycles comprising:
a threaded metal shaft;
a bearing and oil seal on the threaded metal shaft;
a points cover plate, the threaded metal shaft passing through the points cover plate at the bearing and oil seal;
an ornament at a first end of the shaft;
a second end of the shaft being connected to such motorcycle's camshaft;
whereby the ornament spins due to the motion of such drive shaft.

12. A motorcycle external accessory drive comprising:
a metal shaft having distal and proximal ends; the shaft attached coaxially to the motorcycle transmission drive shaft; the shaft having a material and thickness sufficient to withstand the stresses imposed by attachment to the motorcycle transmission drive shaft;
a points cover plate having a passage dimensioned and configured to accept the shaft therethrough with the proximal end within the motorcycle engine camshaft case and the distal end outside of the motorcycle;
the distal end having a connection to an accessory external to the motorcycle.

13. The motorcycle external accessory of claim 12, wherein the connection on the distal end further comprises a slip fit which under a first imposed torque causes the accessory to rotate with the shaft, and under a second imposed torque causes the accessory to slip in relation to the shaft rotation.
